(19) United States
(12) Patent Application Publication
(10) Pub. No.: US 2006/0017566 A1
(43) Pub. Date: Jan. 26, 2006

(54) RF volumetric intrusion detection device, system and method

(76) Inventors: Jean-Louis Gauvreau, La Prairie (CA); Alexandre Cervinka, Montreal (CA); Vincent Kassis, Mont-Royal (CA); Frederic Beaulieu, Montreal (CA); Yvan Castilloux, Montreal (CA); Yves Tessier, La Prairie (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 11/149,243

(22) Filed: Jun. 10, 2005

Related U.S. Application Data
(60) Provisional application No. 60/578,292, filed on Jun. 10, 2004.

(30) Foreign Application Priority Data
Jan. 31, 2005 (CA) 2,495,357

(51) Int. Cl. G08B 13/00

(52) U.S. Cl. 340/541; 340/539.1

(57) ABSTRACT

A device, system and method for the detection of intrusion using radio frequency (RF) signals are provided. The system comprises at least two devices. The system detects intrusion by measuring the Received Signal Strength (RSS) of a RF signal sent by the first device to the second device via a RF channel. The RF signal receiving device determines if the variation of the current RSS value is due to an intrusion in the RF channel or not an acts appropriately.

This is a Continuation-in-Part of application Ser. No. 60/578,292, filed on Jun. 10, 2004.

### FIELD OF THE INVENTION

The present invention generally relates to the detection of intrusion. More specifically, the present invention is concerned with a Radio-Frequency (RF) based device, system and method for the detection of intrusion.

### BACKGROUND OF THE INVENTION

Intrusion detection sensors can be categorized based on their application and underlying technology as shown in FIG. 1 and FIG. 2;

The vast majority of volumetric intrusion sensors that rely on the monitoring of Electro-Magnetic Wave (EMW) propagation in the 30 MHz to 30 GHz band detect motion by transmitting a EMW in the space to be monitored, and then comparing the frequency of the received signal with the frequency of the transmitted signal to detect the Doppler frequency shift associated with any EMW reflecting off a moving body.

There exists some patents relative to the detection of intrusion based of EMW monitoring. However, to the best of our knowledge, all of these patents (e.g. U.S. Pat. No. 3,383,678, U.S. Pat. No. 4,090,195 and U.S. Pat. No. 6,778,132 B2) are based on Doppler shift technology.

The intrusion detection sensors based on the monitoring of the Doppler shift have the following limitations:

A) The operating band must be free of strong emitters of electric fields (e.g. radio transmitters) or magnetic fields (e.g. large electric motors or generators) because the sensor signal processing does not discriminate a third party emission from its own. The presence of a third party EMW in a bandwidth overlapping the operating band of the intrusion system could cause a false alarm by altering the frequency of the signal received by the sensor, effectively mimicking a Doppler shift. This is of particular concern for the development of systems operating in the popular 915 MHz and 2.4 GHz ISM bands used for unlicensed local communications. Zones that contain fluorescent lights can also pose a problem because the ionization cycle created by fluorescent bulbs can be interpreted by the detector as motion and thus provide false alarms.

B) The operating band is typically at higher frequencies, often in the X band (8-12 GHz) or higher, because the Doppler shift caused by slow moving objects can be better observed at higher frequencies. For instance, a person walking very slowly (0.33 m/s) would generate a frequency shift of only 1 Hz for a system operating at 1 GHz, whereas a system operating at higher frequency (e.g. 10 GHz) will see a much higher shift, 10 Hz. Most sensors are tuned to measure a Doppler shift between 20 Hz and 120 Hz. Operating at higher frequencies has several major drawbacks:

First, the cost of components and the complexity of hardware design is higher;

Second, the space that can be monitored by the sensor is further constrained by the shadowing of objects. This is of particular concern for the detection of motion in clustered environments, for instance the detection of an illegal immigrant concealed in a stuffed cargo container;

Third, since most unlicensed local communication technologies operate in lower frequency bands because of better propagation performance, for instance the 915 MHz or the 2.4 GHz ISM bands, the sensing and communication RF front end hardware of the wireless RF sensors cannot be combined;

Fourth, systems working at higher frequencies have higher energy consumption since high frequencies are more energetic than lower frequencies. High energy consumption may not be desirable in a battery powered device.

C) In low duty cycle systems such as battery powered wireless sensors, motion occurring between two Doppler shift measurements (i.e. during the off part of the cycle) will not be detected;

D) Movement in parallel of the incident EMW will create very little Doppler shift, and could therefore go unnoticed;

### Objects of the Invention

An object of this invention is to provide a device, system and method for the detection of intrusion using RF signals;

Another object of the present invention is to provide a device, system and method for the detection of intrusion using the received signal strength (RSS) of RF signals;

Another object of this present invention is to provide a device, system and method for the detection of intrusion which can preferably use the same frequency band for both detection and communication;

Another object of the present invention is to provide a volumetric intrusion detecting device, system and method that can operate in the presence of other non-collaborating systems operating in the same frequency band;

Another object of the present invention is to provide a low duty cycle volumetric intrusion detecting device, system and method that can detect intrusion between two points in time without monitoring the RF signal properties in the continuum;

Another object of the present invention is to provide a volumetric intrusion detecting device, system and method that preferably relies on an encrypted RF reference signal from an authenticated transmitter;

An object of the present invention is to provide a volumetric intrusion detecting device, system and method that can detect motion in a space in which all points are not accessible with a direct line-of-sight, for instance from the exterior of an enclosed space;

Another object of the present invention is to provide a volumetric intrusion detecting device, system and method that can monitor a stuffed freight container for the motion caused by illegal immigrants and the insertion or removal of cargo through a hole in any of the six sides of the container;

A further object of this present invention is to provide a volumetric intrusion detecting device, system and method which can be battery powered;

Another object of the present invention is to provide a volumetric intrusion detecting device, system and method which has a low power consumption;

Another object of this present invention is to provide a volumetric intrusion detecting device, system and method that can be mobile;

A further object of this present invention is to provide a volumetric intrusion detecting device, system and method which can function without interruption over long period of time such as the trans-oceanic trip of a container;

Other objects, advantages and features of the present invention will become more apparent upon reading of the following non-restrictive description of illustrative embodiments thereof, given by way of example only with reference to the accompanying drawings.

### SUMMARY OF THE INVENTION

To attain these objective and other objects which will become more apparent as the description proceeds according to one aspect of the present invention, a RF volumetric intrusion detection devices, system and method are provided.

The RF volumetric intrusion detection implies a RF channel between at least one RF emitting device and at least one RF receiving device. The RF channel is the space between the RF emitting device and the RF receiving device in which the RF signal propagates. The general volume of the RF channel thus generally defines the volume to be under surveillance.

In the present invention, the detection of intrusion is done by measuring the RSS of the RF signal at the RF receiving device. In its most basic embodiment, the RF emitting device transmits a RF signal in the RF channel on a known frequency. The RF receiving device, tuned to the same frequency, receives several copies of the original RF signal, each copy having a different phase due to different propagation path. The RF signal indeed received is the constructive and destructive addition of all these copies. The RF receiving device also includes a module to measure the RSS value of this RF signal. This module then compare the current RSS with a known average value and a known threshold value. Preferably, the known average value is the average of the “N” last measured RSS values, “N” being a predetermined number. If an intrusion occurs in the RF channel, the RSS value on the current RF signal will change since the propagation paths will be different from the last RF signals. If no intrusion occurs, the RSS of the current signal should generally stay stable and the variations of the RSS between consecutives RF signals should generally stay under the predetermined known threshold.

This basic embodiment would work using any RF frequency. However, the Ultra High Frequency (UHF) and more precisely the 433 MHz, the 868 MHz, the 915 MHz and the 2.4 GHz ISM bands are preferred since the frequencies in these bands can be used both for communication and for detection and they don't require a direct line-of-sight. However, these frequencies bands are not free of interferences. To work in these bands, a more sophisticated embodiment of the system is required.

In this more sophisticated embodiment, each device in the system comprises an expert system, a modem, an antenna and a RSS module. In this system, the RF emitting device can send different types of digital messages to the RF receiving device by modulating the RF signal using the modem in conjunction with the digital messages. The modulation techniques are preferably Frequency Shift Keying (FSK) or Frequency Hop Spread Spectrum (FHSS).

Using these devices, the detection of intrusion works in the following way. Since both devices are identical, one device is defined as a master device and the other device as a slave device. The master device first sends a handshake message to the slave device. The slave device sends back a handshake acknowledgement message to confirm its presence in the system.

The master device then selects a frequency and a timeslot for the transmission of RSS message. The frequency and timeslot are encoded in a digital message. The message is then modulated and transmitted to the slave device.

Upon reception of the message, the slave device decodes the message and then extracts the frequency value and the timeslot value. The slave device then tunes itself to the selected frequency and waits for the selected timeslot.

At the selected timeslot, the master device transmits the RSS message. Upon reception of the RSS message, the slave device measures the RSS value the signal of the RSS message. The expert system of the slave device then compares the current value with the known moving average RSS value and a known threshold value. The expert system then decides if the variation of the current RSS value in relation to the average RSS value exceeds the known threshold. Whether or not an intrusion has occurred, the information is encoded in an alarm status message by the slave device. The slave device then transmits the alarm status message to the master device.

To increase the security of the system, all the messages would preferably be encrypted using preferably a symmetric key scheme. Thus, every messages received by either device would need to be authenticated upon reception.

Both systems presented could be extended to more than two devices. Each combination of pair of devices preferably working at different frequency and having a different coverage area. The areas could also overlap to increase the surveillance.

The devices presented in this inventions can be as sophisticated as desired. In the most basic system, the RF emitting device can only comprise a RF signals generator connected to an antenna. The frequency of the RF emitting device being set by the user of the device with means known in the art. The RF receiving device would comprise an antenna connected to a filter to select only the good frequency. The filter would be connected to the RSS measurement circuitry or Integrated Circuit (IC). This circuitry or IC would be connected to the expert system to process the RSS value and determine if an intrusion has occurred. The expert system could be made of custom circuitry, programmable chips, micro-controller or an Application Specific Integrated Circuit (ASIC). The expert system could control a Light Emitting Diode (LED) to signal an intrusion.

The device of the more sophisticated system comprises more components. First, there is the expert system which, in this embodiment, has several tasks. First, it generates, encodes, preferably encrypts, decodes and preferably authenticates all the different messages sent and received during the operation of the system. The expert system also controls the modem by determining which frequency to use. Finally, the expert system also processes the RSS value and determines if an intrusion has occurred. As mentioned before, the expert system can be built from custom circuitry, programmable chips, micro-controller or ASIC. The expert system is thus connected to the modem and the modem is connected to the antenna. The expert system is also connected to the RSS measurement module. This module comprises a band filter connected to a Low Noise Amplifier (LNA). The LNA is connected to a mixer which also receives signals from a Voltage Controlled Oscillator (VCO) which is itself controlled by a Phase Lock Loop (PLL). The mixer is connected to a saw filter which is connected the an amplifier. Finally, the amplifier is connected to a power detector which effectively measures the RSS value. This power detector is connected to the expert system.

This device could also include a real-time clock module to record at which time the intrusion occurred. It could also include a GPS module and various wireless network modem to communicate with an outside computer.

The invention accordingly comprises the systems, methods and devices which will be exemplified in the description of the preferred embodiment hereinafter set forth. However, the above summary of the invention is by no mean restrictive and the invention includes all the variations within the scope of the invention that will be indicated in the claims.

### BRIEF DESCRIPTION OF THE DRAWINGS

In the appended drawings:

FIG. 1 presents the technological categories of interior intrusion detection sensors;

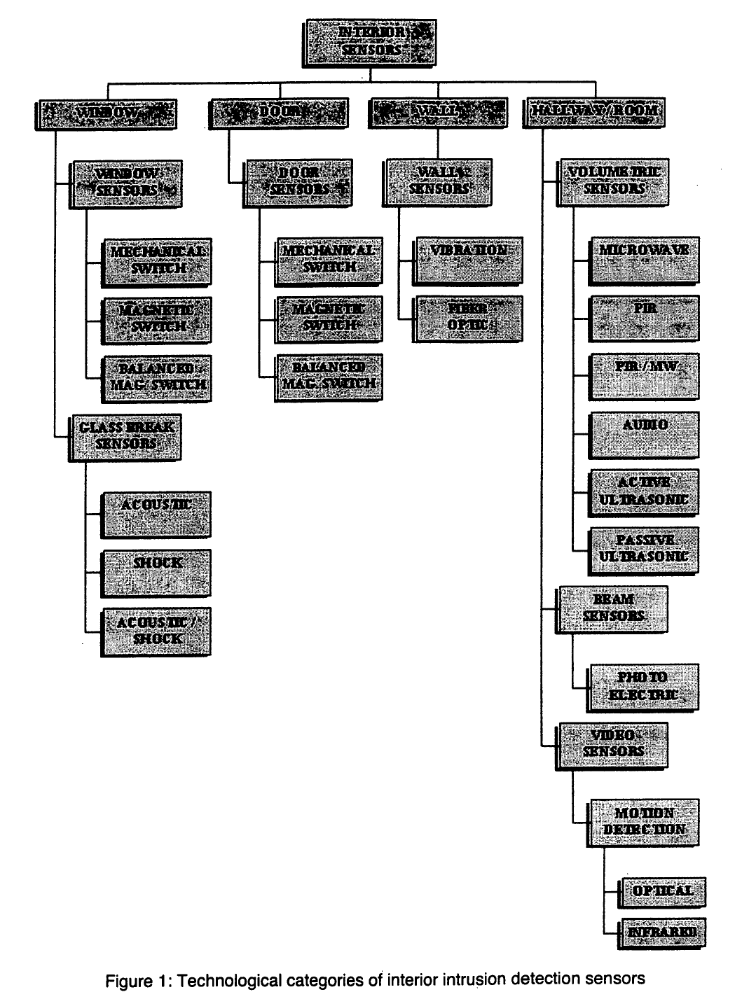

FIG. 2 presents the technological categories of exterior intrusion detection sensors;

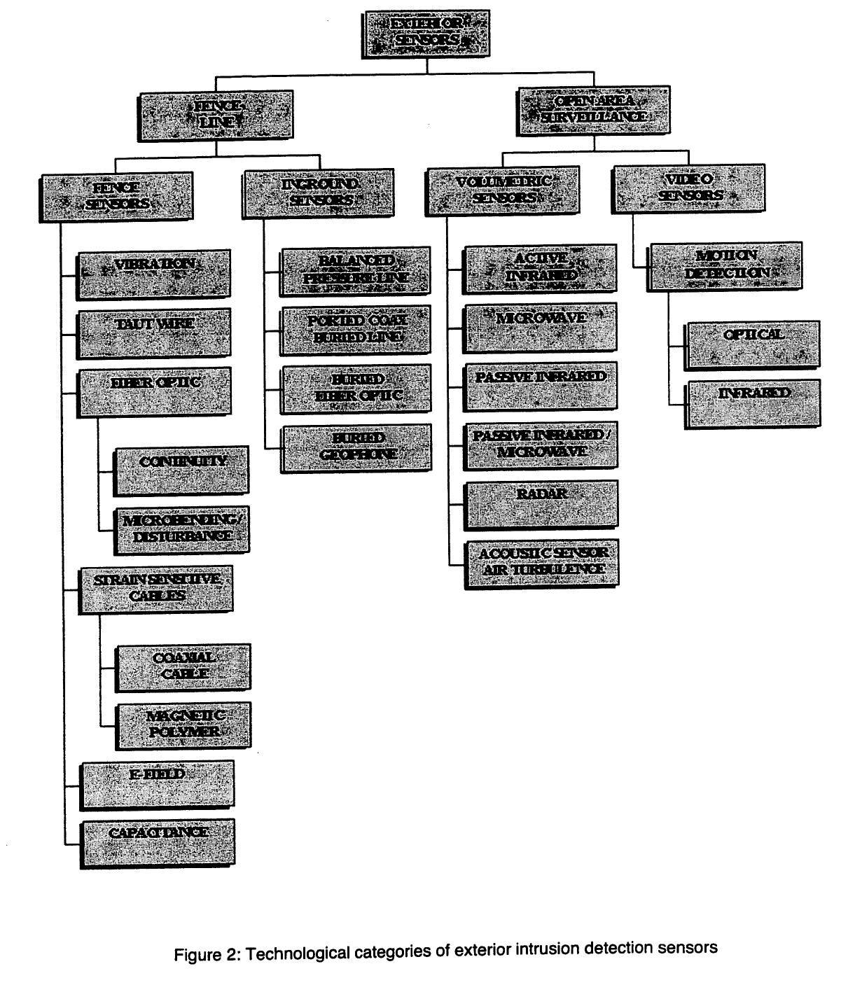

FIG. 3 schematically illustrates an intrusion detection system with two node devices, according to an embodiment of the present invention;

FIG. 4 is a hardware block diagram of a node device as shown in FIG. 1;

FIG. 5 presents sample plots of the RF Received Signal Strength (RSS) sensor output of the device shown in FIG. 3 over time in an office setting;

FIG. 6 presents sample plots of the RF Received Signal Strength (RSS) sensor output of the device shown in FIG. 3 over time in a freight container setting with both node devices inside the container;

FIG. 7 presents sample plots of the RF Received Signal Strength (RSS) sensor output of the device shown in FIG. 3 over time in an freight container setting with one node device inside the container and one outside;

FIG. 8 illustrates the result of the intrusion detection signal processing algorithm applied to the Received Signal Strength (RSS) sensor output of FIG. 5;

FIG. 9 is a flowchart of an embodiment of the intrusion detection method of the present invention.

FIG. 10 is an example of a multinode embodiment of the present invention.

### DETAILED DESCRIPTION OF A PREFERED EMBODIMENT

With reference to the annexed drawings, the preferred embodiment of the present invention will be herein described for indicative purposes and by no means as of limitation.

The drawings and the description attached to it are only intended to illustrate the idea of the invention. As to the details, the invention may vary within the scope of the claims.

Prior to the description of a preferred embodiment of the present invention, some important concepts must be generally explained in order to better understand the present invention.

A RF channel is generally defined as the space between a transmitter and a receiver through which the radiated RF Electro-Magnetic Waves (EMW) propagates. The delimited space depends on the location of transmitter and receiver, the radiating pattern of the antennas and the environment.

Multipath fading occurs when multiple copies of the signal arrive at a radio at the same time but with different phases. The Received Signal Strength (RSS) at the receiver is a function of the constructive and destructive additions of the impinging waves. Intrusion in the RF channel will thus change the multipath pattern and therefore, change the RSS at the receiver.

Multipath fading in a given environment varies with the carrier frequency. Additional crosschecking is therefore possible by varying the carrier frequency of the signal. For instance, one could take advantage of Frequency Hopping Spread Spectrum (FHSS) communications to add frequency diversity in the intrusion detector system.

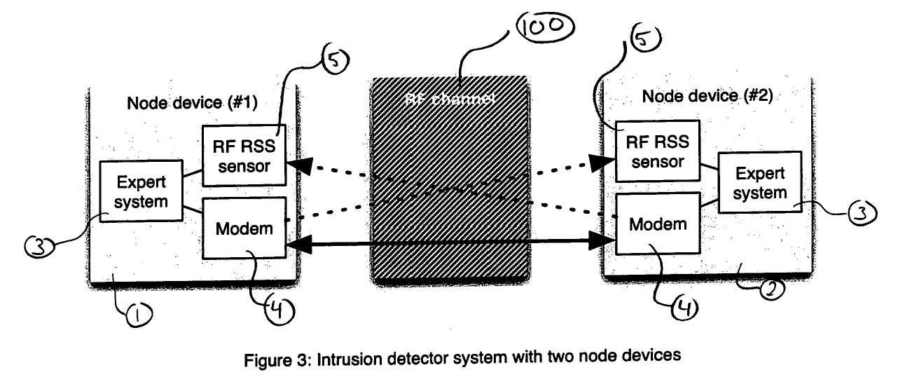

The intrusion detector system illustrated in FIG. 3 detects intrusion in the RF channel (100). The system must have at least two nodes (1) and (2), and at least one of the two nodes must have an RF RSS sensor (5).

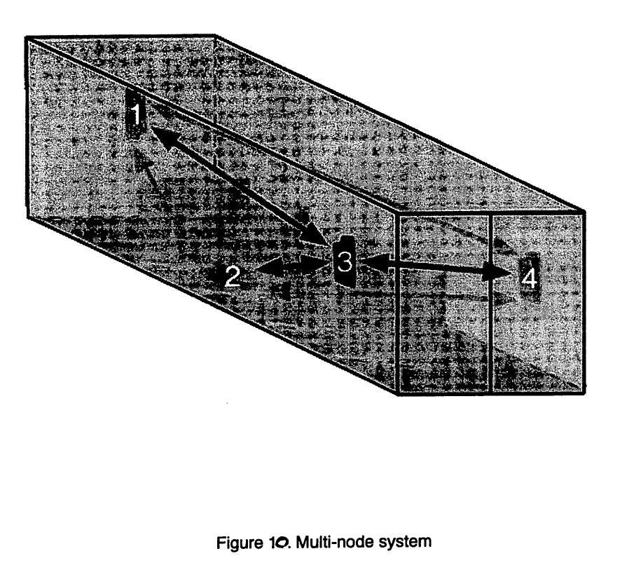

In another embodiment of the present invention, the intrusion detector system illustrated in FIG. 3 could be extended to N nodes (shown in FIG. 10), where the RF channels between each pair of nodes can overlap for crosschecking, or coexist in parallel to extend the coverage area.

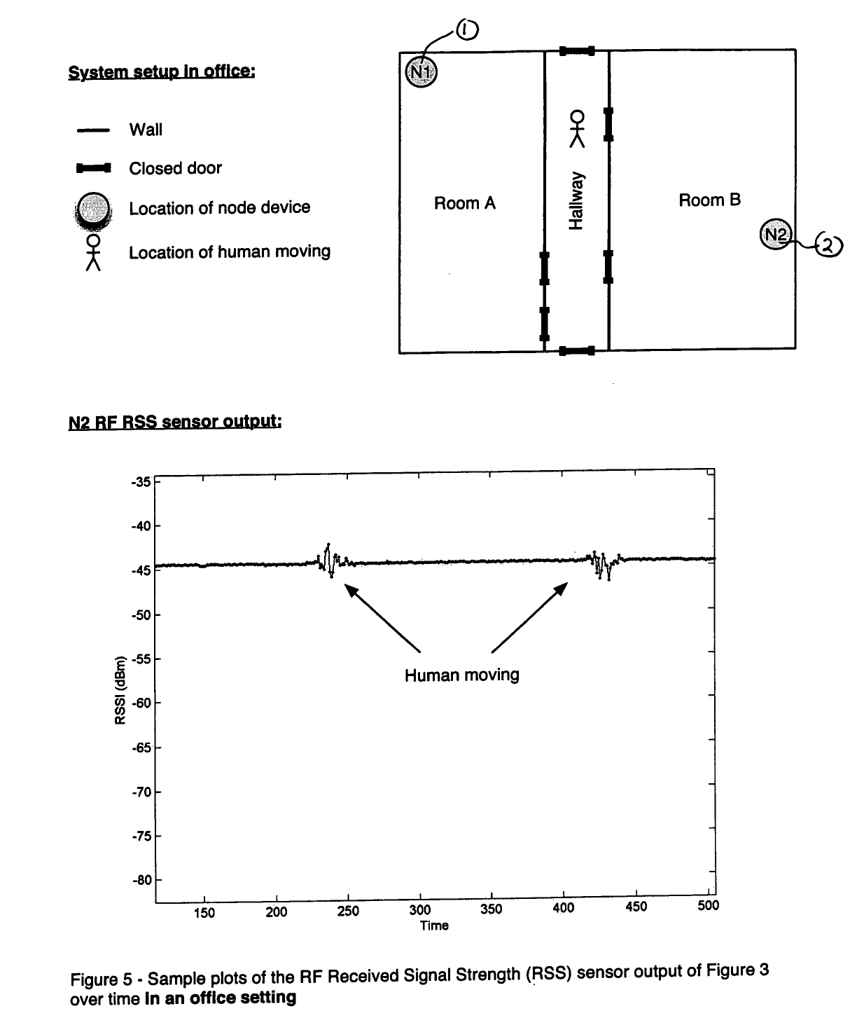

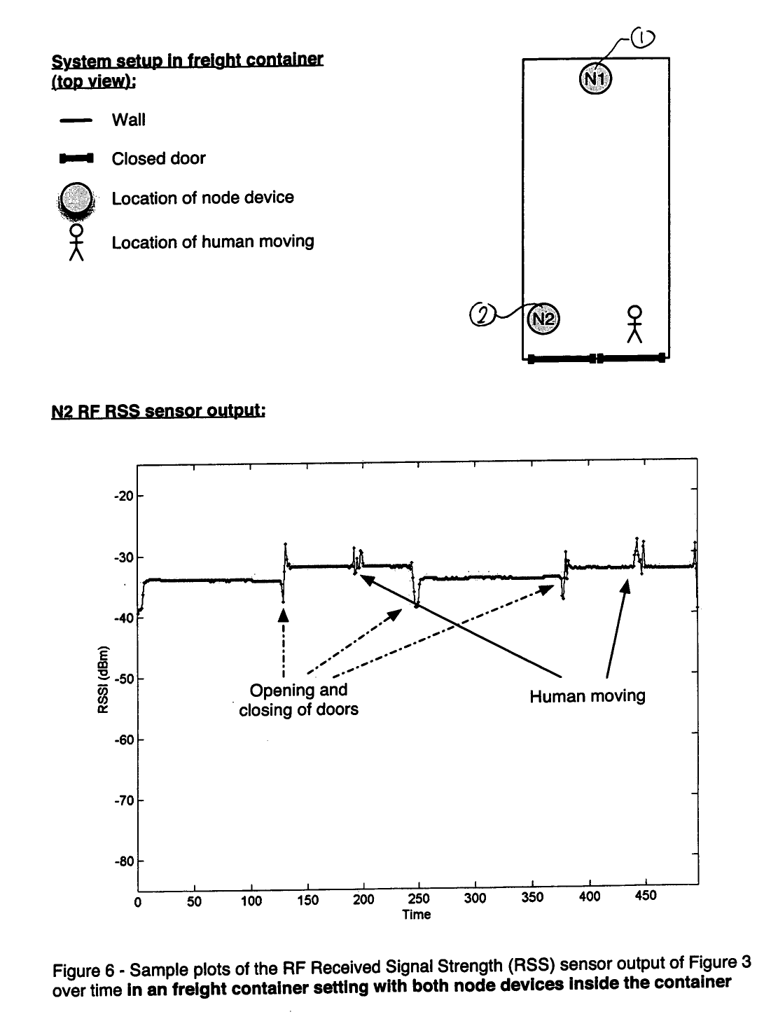

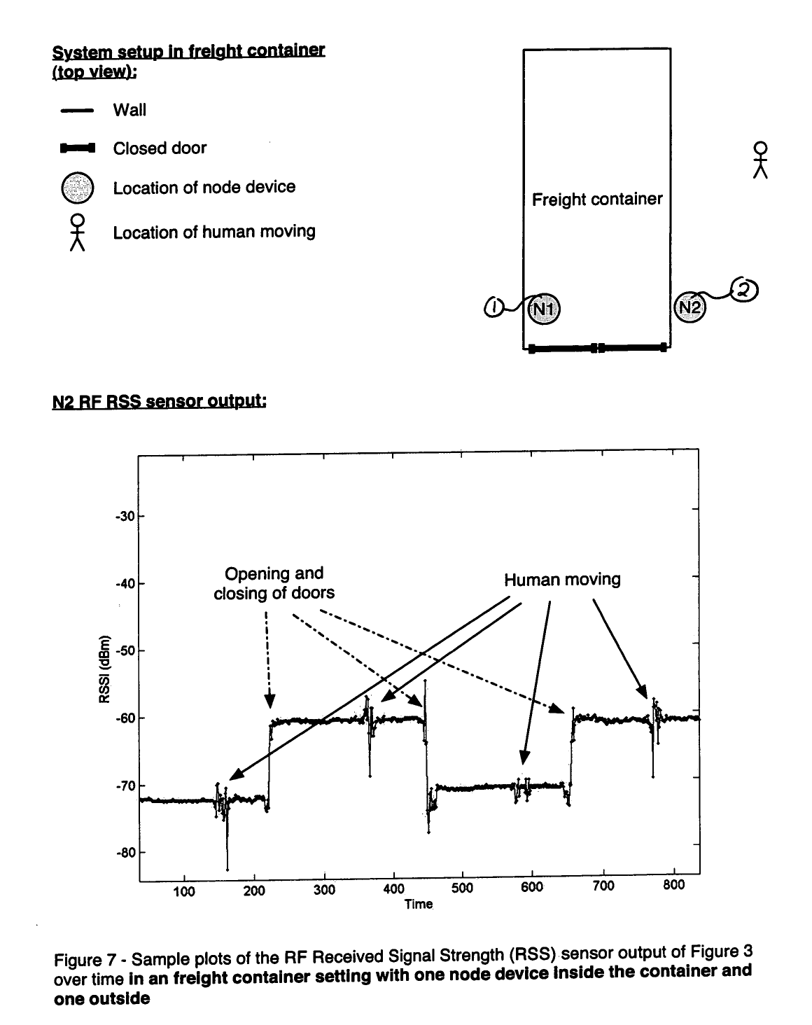

Referring to FIGS. 5, 6 and 7, the two node devices (1) and (2) are positioned at two different physical places in the area to be under surveillance. Places such as two different rooms (FIG. 5), two different walls in a freight container (FIG. 6) or inside and outside a freight container (FIG. 7) are good examples. The area under surveillance is generally bounded by the RF channel between the two node devices.

Referring to FIG. 3, one of the node devices preferably acts as a master node device whereas the other node device preferably acts as a slave node device. For illustrative purpose, node device (1) could be the master node device whereas node device (2) could be the slave node device. In the description thereafter, “device” will refer to “node device”.

The master device (1) comprises at least an expert system (3) and a modem (4). The master device can also have a RF RSS sensor (5).

The slave device (2) comprises at least an expert system (3), a modem (4) and a RF RSS sensor (5). In the embodiment of FIG. 3, the master device and slave device both have an expert system (3), a modem (4) and a RF RSS sensor (5). Their respective role as master device and slave device are thus effectively interchangeable.

A method for the detection of intrusions in the volume generally bounded by the RF channel existing between the master device (1) and slave device (2) will now be described.

The master device (1) expert system (3) generates a preferably encrypted authentication message. The authentication message is sent to the master device (1) modem (4). The master device (1) modem (4) modulates the authentication message using a known modulation technique such as Frequency Shift Keying (FSK). The master device (1) modem (4) can also use Frequency Hopping Spread Spectrum (FHSS) in order to add robustness and a relative immunity to local interferences. The master device (1) modem (4) then sends the modulated authentication message, to the slave device (2), in the RF channel (100) and on a frequency known by the master device and the slave device.

The data rate of the authentication message is preferably low in order to be more robust in high attenuation environment. A preferred range of rates would be 4.8 kbps to 128 kbps.

All the messages sent between the master device (1) and the slave device (2) are preferably encrypted.

The encryption scheme used to encrypted the messages could be symmetric keys.

In the case where a FHSS technique is used for the communication between the master device (1) and the slave device (2), both devices know the frequency hopping sequence. The hopping sequence is determined by the master device (1).

The slave device (2) receives the modulated authentication message in the form of a RF signal from the master device (1). The slave device (2) modem (4) demodulates the received signal. The slave device (2) modem (4) then sends the authentication message to the slave device (2) expert system (3). The slave device (2) expert system (3) verifies the authenticity of the received authentication message. If the received authentication message is valid, the slave device (2) waits for the timeslot in which the RSS measurement message will come from the master device (1). Otherwise, the slave device (2) discards the received authentication message.

At the specified timeslot, the master device (1) sends the RSS measurement message to the slave device (2) using the modem (4) and the RF channel (100).

The slave device (2) receives the modulated RSS measurement message from the master device (1). The slave device (2) expert system first authenticates the received RSS measurement message and, if valid, proceeds with the measurement of the RSS of the received RSS measurement message. If invalid, the slave device (2) discards the received RSS measurement message.

If the slave device (2) proceeds with the measurement of the RSS of the received RSS measurement message RF signal, the slave device (2) switches a sample of the received RSS measurement message RF signal to the slave device (2) RSS sensor (5). The slave device (2) RSS sensor (5) measures the RSS of the received RSS measurement message RF signal. The slave device (2) RSS sensor (5) sends the value of the RSS of the received RSS measurement message RF signal to the slave device (2) expert system (3). The slave device (2) expert system (3) compares the RSS to previous values of previous RSS measurement message RSS.

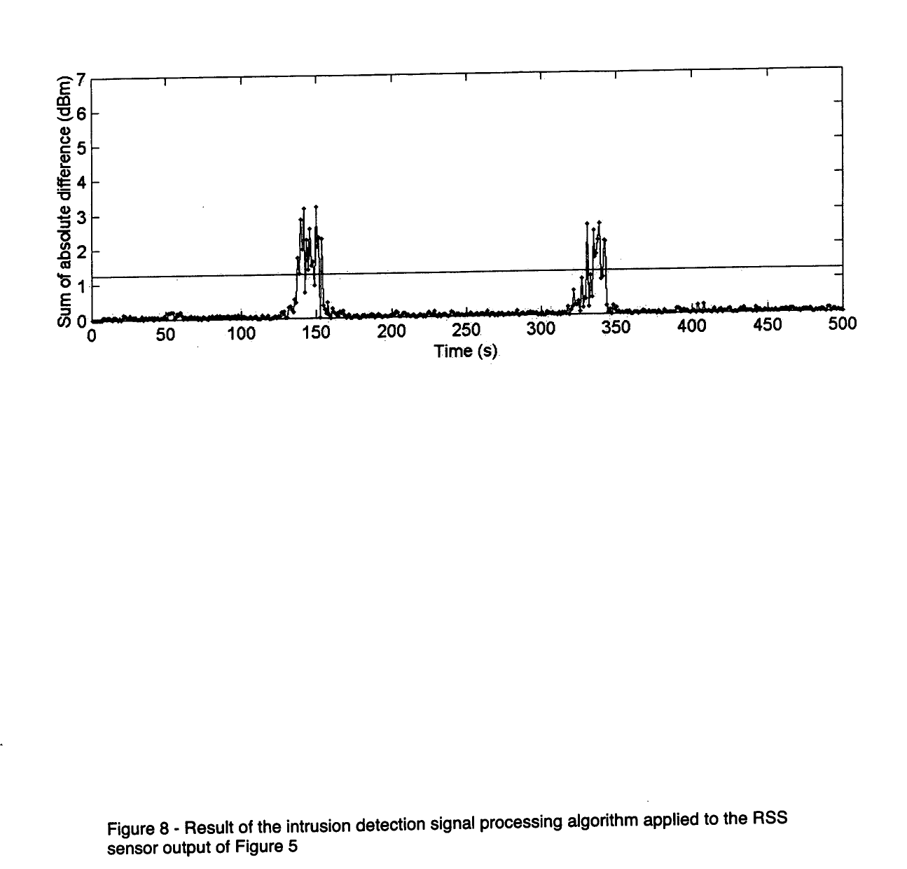

One possible algorithm for the detection of intrusion in the RF channel will now be described. The slave device (2) expert system (3) monitoring the RSS sensor output detects intrusion in the RF channel by comparing the moving average of absolute differences between consecutive RSS samples on a given frequency over a fixed time window with the user specified sensitivity threshold. FIG. 8 provides the result of the latter algorithm when applied to the RSS sensor output of FIG. 3. All the samples are on the same frequency. The absolute difference is derived by comparing each new sample with a sample measured previously at a fixed delay in samples (d). The absolute difference is added to the last (n−1) calculated absolute differences, where n is the window period in number of samples used for the moving average. In the results shown in FIG. 8, the moving average period (n) was set to 4 samples, the fixed delay to 4 samples, and the movement detection threshold was set to 1.25 dBm.

Once the analysis of the RSS of the received RSS measurement message is done, the slave device (2) expert system (3) decides if an intrusion has occurred in the RF channel (100) using the algorithm. The slave device (2) then sends an alarm status message to the master device (1) using the slave device (2) modem (4) and the RF channel (100).

The master device (1) receives the alarm status message. The master device (1) expert system (3) authenticates the received alarm status message and if valid, stores the alarm status for further analysis by a custom agent for example.

In this preferred embodiment, every node device would comprise an expert system (3), a modem (4) and a RSS sensor (5). Moreover, every node device would have 3 modes of operation: the transmission mode, the receiving mode and the receive sensitivity mode.

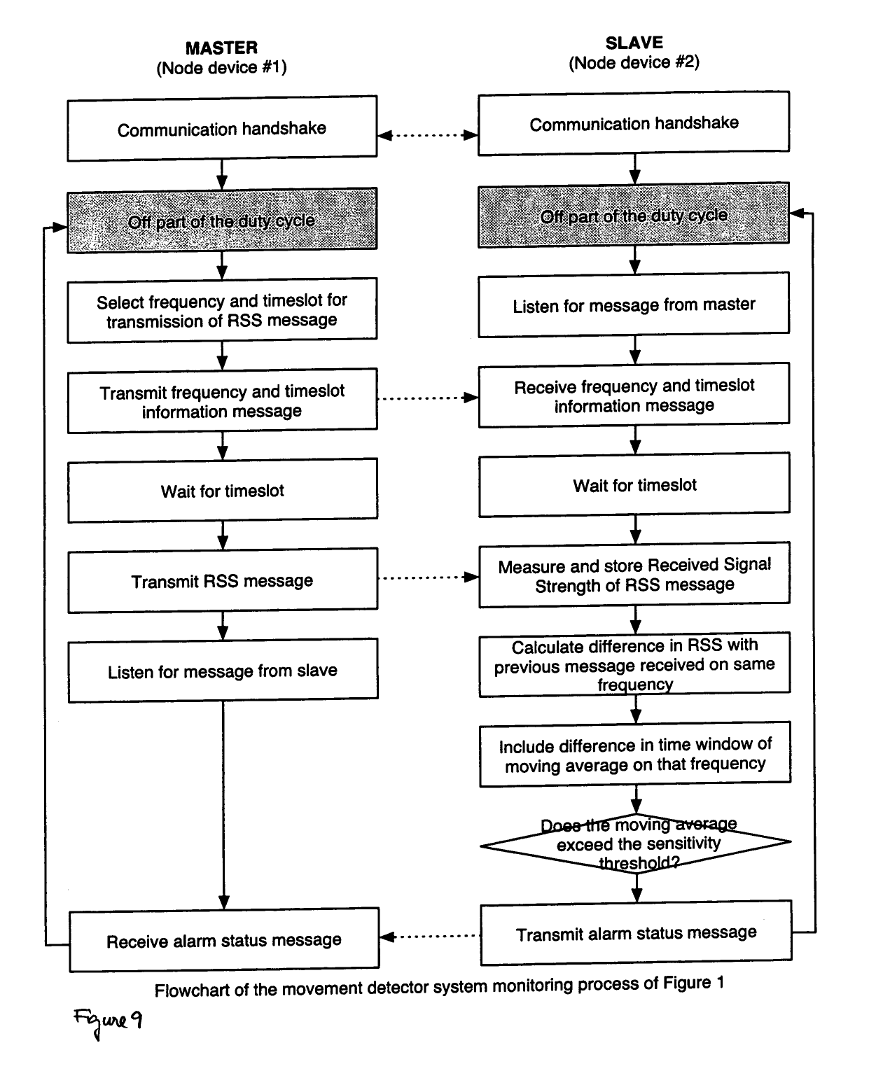

FIG. 9 provides a general flowchart of the preferred intrusion detection method. The process begins by a communication handshake, which includes mutual discovery and authentication, using a symmetric key shared by both devices. Both devices then enter the off part of their duty cycle. When the on part of the duty cycle starts, the master device (1), which is responsible for the synchronization of the Frequency Hopping Spread Spectrum (FHSS) on the channel, selects the frequency and timeslot that will be used for the transmission of the message who's RSS will be measured. This information is encrypted using the symmetric key and sent to the slave device (2). The slave device (2) receives and decrypts the message, and then waits for the timeslot of the RSS message. At the specified timeslot, the master device (1) transmits the encrypted RSS message, and waits for the alarm status message from the slave device (2). The slave device (2) receives the RSS message, measures and stores the Received Signal Strength (RSS), authenticates the transmitter by decrypting the message, uses the expert system (3) and specified threshold to determine if an intrusion has occurred. The slave device (2) encrypts the alarm status message using the symmetric key, transmits the encrypted message to the master device (1), and then enters the off part of the duty cycle. The master device (1) receives the alarm status message, authenticates the slave device (2) by decrypting the message, and then returns to the off part of the duty cycle.

The master node device in FIG. 9 can also ask the slave to transmit an RSS message, effectively reversing the roles in the process;

The node devices can periodically mutually confirm that they are still operational in order to detect the destruction, tampering or malfunction of a device;

The node devices could be connected to a Wide Area Network (WAN) modem for transmission of alarm data to a central monitoring center.

The node device may also include a real time clock to store the date and time at which an alarm is triggered.

The node device could operate in any band in the UHF band (300 MHz-3 GHz) without significant impact on the performance. A node device operating in the 2.4 GHz unlicensed band could be an excellent choice.

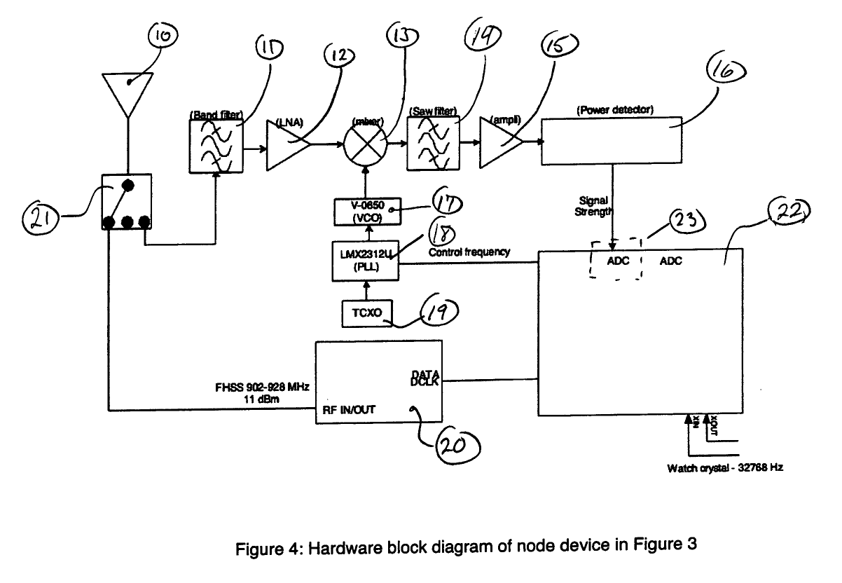

FIG. 4 shows one preferred embodiment of the internal structure of the node device.

The emission or the reception of a RF signal at a node device is done via the antenna (10). The antenna (10) is connected to a switch (21). In the transmission or reception mode, the switch is configured to connect the antenna to the modem (20). The modem (20) is connected to the expert system (22). The expert system (22) can be implemented on a micro-controller, a custom circuit, a programmable integrated circuit such as a Field Programmable Gate Array (FPGA), an Application Specific Integrated Circuit (ASIC) or other likely programmable chips. The expert system (22) is connected to a Phase Locked Loop (PLL) circuit or chip (18) whom it controls via a control frequency. The PLL is also controlled by a Temperature Compensating Crystal Oscillator (TCXO) (19). The PLL (18) is connected to a Voltage Controlled Oscillator (VCO) circuit or chip (17). The VCO (17) is connected to a mixer (13). In the RSS measurement mode, the switch (21) is configured to connect the antenna (10) to a band filter (11). The band filter (11) is connected to a Low Noise Amplifier (LNA) (12). The LNA (12) is connected to the mixer (13). The mixer (13) is connected to a saw filter (14) to which the mixed signal is sent. The saw filter (14) is connected to an amplifier (15). The amplifier (15) is connected to a power detector (16). The power detector (16) is connected to a Analog to Digital Converter (ADC) (23) which can be included in the expert system (22). The ADC (23) is connected to the expert system (22).

The use of a mixer and an IF (Intermediary Frequency) is facultative and has been done to simplify the channel filtering. The bandwidth of the channel filtering is not critical.

Although the present RF volumetric intrusion detection device, system and method have been described with a certain degree of particularity, it is to be understood that the disclosure has been made by way of example only and that the present invention is not limited to the features of the embodiment described and illustrated herein, but includes all variations and modifications within the scope and spirit of the invention hereinafter claimed.

The embodiments of the invention in which an exclusive property or privilege is claimed are defined as follows:

1. A system for the detection of volumetric intrusions in the RF channel defined between two RF transmitting-receiving devices, said detection being done over a period of time, said system comprising:
a. A first device comprising a mean to transmit RF signals;
b. A second device comprising:
i. a mean to receive said RF signals;
ii. a mean to detect if an intrusion has occurred in said RF channel using the RSS of said RF signals.

2. The system, according to claim 1, wherein said mean to detect an intrusion in said RF channel comprises:
a. A mean to measure the RSS value of the said RF signals;
b. A known comparison value;
c. A predetermined threshold value;
d. A mean to compare the said RSS value with the said comparison value using the said threshold value;
e. A mean to determine if the said RSS value exceeds the said threshold value;

3. A method for the detection of volumetric intrusions in the RF channel defined between two RF transmitting-receiving devices, said method involving the system according to claim 2, said method comprising:
a. Installing said RF emitting device;
b. Installing said RF receiving device;
c. Selecting the RF signal frequency;
d. Tuning said RF emitting device and said RF receiving device to said frequency;
e. Said RF emitting device transmitting said RF signal in said RF channel at said frequency;
f. Said RF receiving device receiving said RF signal;
g. Said RF receiving device using said mean to detect if an intrusion has occurred using the RSS value of said RF signal;
h. Said mean to detect an intrusion determining if an intrusion has occurred;
i. Said RF receiving device sending a signal if an intrusion has occurred.

4. The RF emitting device according to claim 1, wherein said mean to transmit said RF signal comprises:
a. A RF signal generator;
b. A RF frequency tuner;
c. An antenna.

5. The RF receiving device according to claim 1, wherein said mean to receive said RF signal comprises:
a. An antenna;
b. A RF frequency tuner;
and wherein said mean to detect if an intrusion has occurred using the RSS of said RF signal comprises:
c. A filter;
d. A power detector;
e. An expert system to determine if said RSS value of said RF signal indicates that an intrusion has occurred.

6. The system according to claim 1, wherein said RF signals are in the Radio Frequency spectrum.

7. The system according to claim 6, wherein said RF signals are in the Ultra High Frequency (UHF) band.

8. The system according to claim 7, wherein said RF signals are in the 2.4 GHz ISM unlicensed band.

9. The system according to claim 7, wherein said RF signals are in the 868 MHz ISM unlicensed band.

10. The system according to claim 7, wherein said RF signals are in the 915 MHz ISM unlicensed band.

11. The system according to claim 7, wherein said RF signals are in the 433 MHz ISM unlicensed band.
